(19) United States
(12) Patent Application Publication
(10) Pub. No.: US 2009/0094133 A1
(43) Pub. Date: Apr. 9, 2009

(54) ORDERING ASSISTANT

(75) Inventors: Karen E. Oates, Wareham, MA (US); Heng C. Chen, Bethesda, MD (US); Juan F. Arias, Fishkill, NY (US); Meluaku M. Mitchel, Silver Spring, MD (US); Christian Lusty, Haslet, TX (US)

Correspondence Address: VERIZON;PATENT MANAGEMENT GROUP, 1320 North Court House Road, 9th Floor, ARLINGTON, VA, 22201-2909, US

(73) Assignee: Verizon Services Corp., Arlington, VA (US)

(21) Appl. No.: 11/868,149

(22) Filed: Oct. 5, 2007

(51) Int. Cl. G06Q 30/00; G06F 19/00

(52) U.S. Cl. 705/26

(57) ABSTRACT

A request is received to configure an order for services. A question tree is accessed, the question tree being related to a form that may be used to place the order. User responses are received to two or more questions included in the question tree. A configuration output is provided that identifies fields in the form to be populated and values for the fields in the form that are to be populated.

### BACKGROUND INFORMATION

Ordering products and/or services may be complicated and confusing, particularly when many product/service configurations are available. For example, ordering network services may be particularly complicated. A customer or provisioning agent may be required to complete a complicated paper or electronic form requesting information in an obscure manner. Forms for requesting network services generally use ill-defined and/or confusing acronyms. Further, such forms generally do not provide any indication of a relationship between various form fields. Therefore, a customer or provisioning agent is unlikely to understand all of the form fields that should be completed when requesting network services. Even if the customer or provisioning agent understands the meaning of each form field, which is unlikely, the customer or provisioning agent is unlikely to identify properly form fields that should and should not be completed when requesting network services.

### BACKGROUND INFORMATION

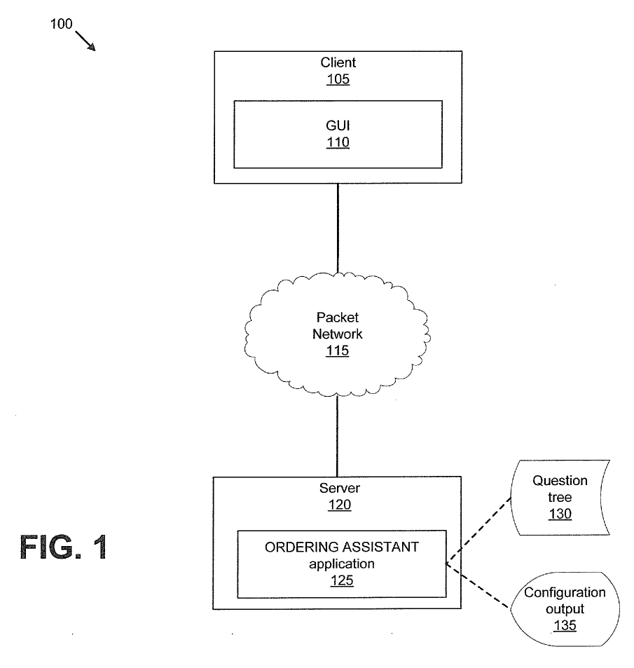

FIG. 1 illustrates an exemplary ordering assistant system.

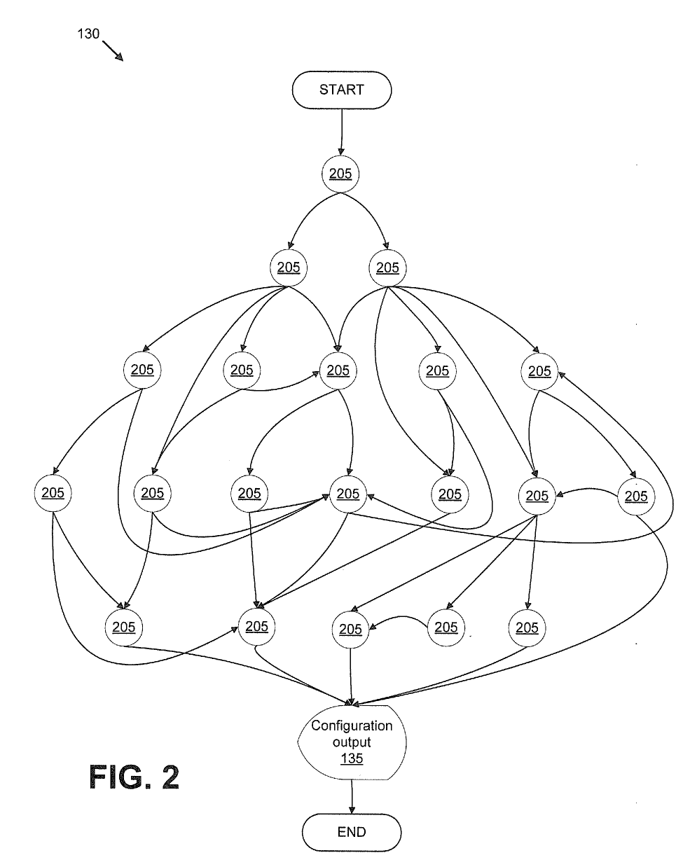

FIG. 2 illustrates an exemplary question tree.

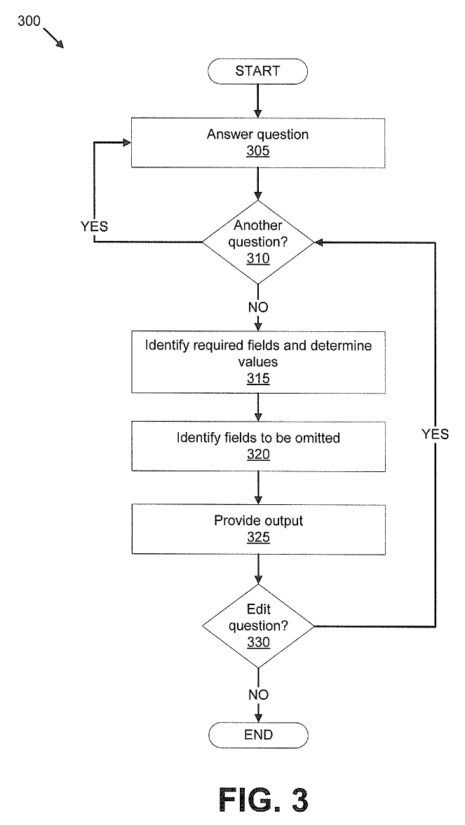

FIG. 3 illustrates an exemplary process for using a question tree to obtain configuration output.

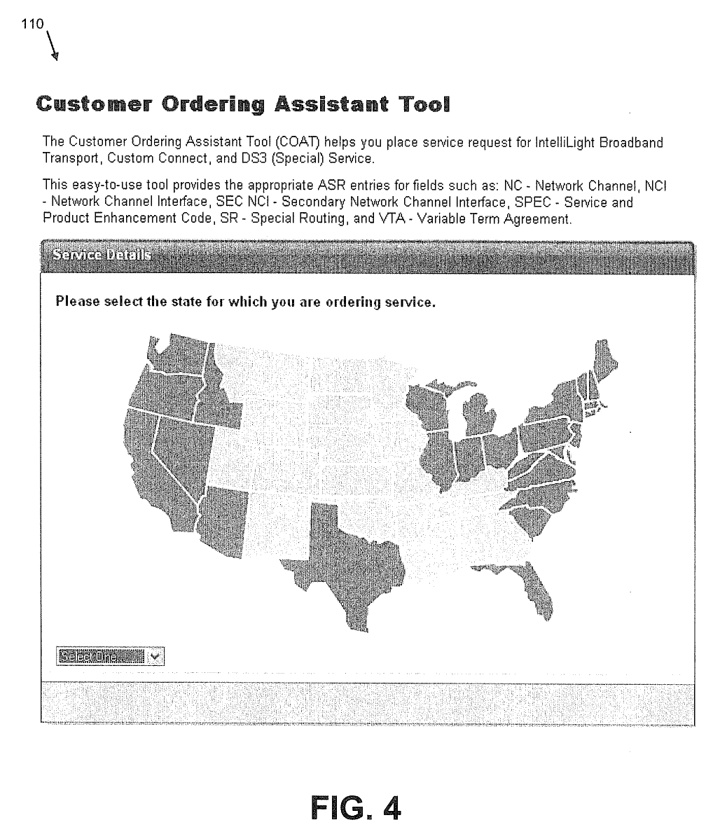

FIGS. 4-12 provide exemplary illustrations of a graphical user interface as it may be provided by a configuration assistant application as a user navigates through a question tree.

### DETAILED DESCRIPTION OF THE PREFERRED EMBODIMENTS

FIG. 1 illustrates an exemplary ordering assistant system 100. As seen in FIG. 1, a client 105 includes a graphical user interface (GUI) 110 that is displayed in a standard web browser, e.g., Microsoft Internet Explorer, or the like. Client 105 is generally in communication via a packet network 115 with a server 120 that includes a configuration assistant application 125. Server 120 generally provides instructions, e.g., according to instructions in application 125, according to which client 105 displays GUI 110. Configuration assistant application 125 further generally includes a question tree 130 that associates questions and their responses to one another to obtain information that may be used to provide configuration output 135.

By way of illustration and not limitation, certain aspects of the ordering assistant system 100 may be understood with reference to the “Access Service Request” form provided by the Alliance for Telecommunications Industry Solutions, 1200 G Street NW, Suite 500, Washington, DC 20005. In one exemplary implementation, configuration assistant application 125 obtains answers to questions displayed in GUI 110. Based on these answers, configuration assistant application 125 determines a configuration for a product and/or service desired by a user, and provides configuration output 135 for display in GUI 110. The output 135 lists fields in the Access Service Request form that should be filled in, along with values to be included in such fields. Further, based on the answers, configuration assistant application 125 in this exemplary implementation lists in output 135 fields in the Access Service Request form that should not be filled in to obtain the desired product and/or service. Because the Access Service Request form generally identifies its fields only with acronyms and/or abbreviations that do not make clear to a layperson what information is being sought, and because the interrelationships of fields in the Access Service Request form may not be clear or known to the person completing the form, configuration output 135 is extremely useful to persons such as customers, provisioning agents, etc. needing to complete the Access Service Request form.

Returning to FIG. 1, client device 105 may be any one of a number of computing devices, such as a server computer, personal computer, handheld computing device, cellular telephone, etc. Although only one client device 105 is shown in FIG. 1 for ease of illustration, system 100 generally includes multiple, indeed many, client devices 105. Client device 105 generally includes a processor, a display for displaying GUI 110, input mechanisms such as a keyboard, keypad, pointing device, etc., as well as a memory and/or other computer readable media for storing instructions to be executed by the processor. Further, client device 105 generally includes a network interface or the like for connecting to packet network 115.

As mentioned above, client device 105 generally includes a web browser or other programming for displaying a GUI 110 provided from server 120. Accordingly, GUI 110 is generally provided according to protocols and/or technologies such as hypertext transfer protocol (HTTP), hypertext markup language (HTML), JavaScript, VBScript, Java server pages, active server pages, etc.

Packet network 115 is a packet switched communication network e.g., an Internet Protocol (IP) network that is a wide-area network (WAN) such as the Internet. Packet network 115 generally interconnects various computing devices and the like, such as client device 105, server 120, etc. Interconnections in network 115 may be made by various media including wires, radio frequency transmissions, optical cables, etc. Packet network 115 generally maintains a common addressing scheme such that each connected device is uniquely addressable by a network address. Routing devices generally interconnect local area networks (LANs), not shown in FIG. 1, that may include devices such as client device 105. Other devices connecting to packet network 115, e.g. switches, intervening routers, etc., are omitted for simplicity of illustration in FIG. 1

Server 120 is generally a general purpose computing device that includes a processor and a memory and/or other computer readable media for storing instructions to be executed by the processor, such as instructions included in configuration assistant application 125. Server 120 may also include a display, input mechanisms such as a keyboard, pointing device, etc., and further generally includes a network interface for connecting to network 115. Server 120 may be associated with a data storage device or the like (not shown in FIG. 1) for storing configuration assistant application 125 and/or data accessed by configuration assistant application 125.

Configuration assistant application 125 generally includes instructions stored on a computer-readable medium, and executable by a processor, e.g., a medium and processor included in or accessible to server 120, for providing GUI 110 to client 105, e.g., via the World Wide Web or the like. Further, application 125 generally includes instructions for accessing question tree 130, and for navigating question tree 130 according to inputs received from client 105 to GUI 110. Application 125 also generally includes instructions for providing configuration output 135, generally after question tree 130 has been navigated.

Question tree 130 is described in more detail below with respect to FIG. 2. In general, question tree 130 includes a set of questions that may be displayed in GUI 110 along with a set of possible answers to the questions. That is, the questions in question tree 130 may have two or more, but not an infinite number, of possible responses, which possible responses are displayed in GUI 110. According to program instructions included in application 125, a response to a first question determines selection of a second question. Thus, a user may be presented with a series of questions, where each question presented to the user, except for the first question presented to the user, is selected according to user input provided in response to the previous question. Exemplary questions and responses are illustrated in FIGS. 4-11, discussed below.

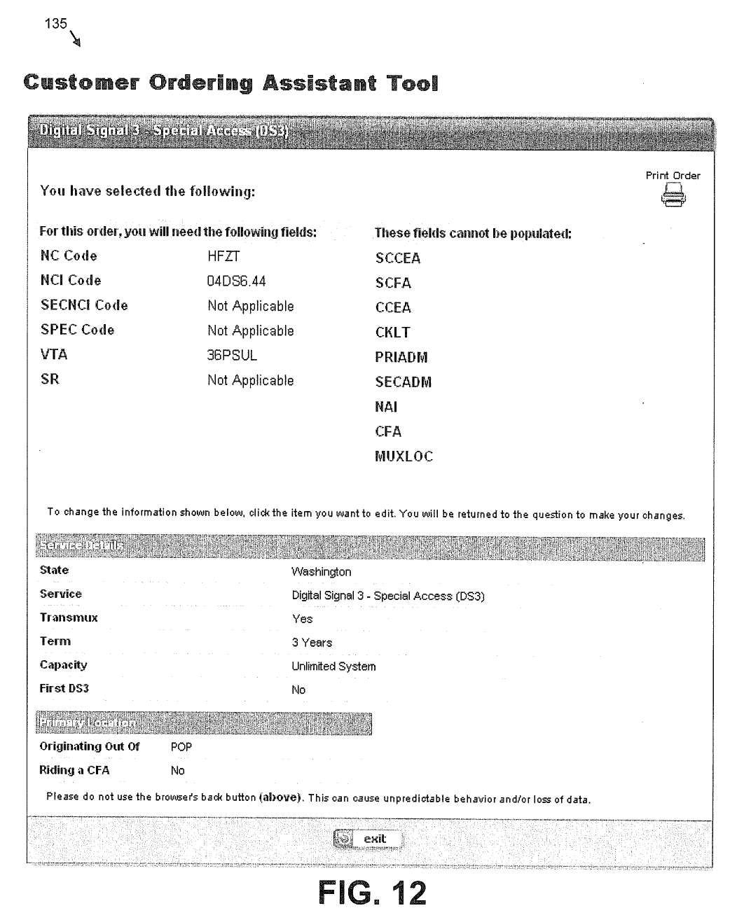

As mentioned above, configuration output 135 may be displayed in GUI 110 after question tree 130 has been navigated. An example of configuration output 135 is shown in FIG. 12 below. In general, configuration output 135 includes information whereby a user may fill out a form ordering a product and/or a service, such as the Access Service Request form discussed above. The information included in configuration output 135 generally includes information regarding fields that should be filled in on the form, and values for such fields, as well as information regarding fields that may not be filled in to order the desired product and/or service.

In general, computing devices such as client device 105, server 120, etc. may employ any of a number of computer operating systems known to those skilled in the art, including, but by no means limited to, known versions and/or varieties of the Microsoft Windows® operating system, the Unix operating system (e.g., the Solaris® operating system distributed by Sun Microsystems of Menlo Park, Calif.), the AIX UNIX operating system distributed by International Business Machines of Armonk, N.Y., and the Linux operating system. Computing devices may include any one of a number of computing devices known to those skilled in the art, including, without limitation, a computer workstation, a desktop, notebook, laptop, or handheld computer, or some other computing device known to those skilled in the art.

Computing devices generally each include instructions executable by one or more computing devices such as those listed above. Computer-executable instructions may be compiled or interpreted from computer programs created using a variety of programming languages and/or technologies known to those skilled in the art, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium includes any medium that participates in providing data (e.g., instructions), which may be read by a computer. Such a medium may take many forms, including, but not limited to, non-volatile media, volatile media, and transmission media. Non-volatile media include, for example, optical or magnetic disks and other persistent memory. Volatile media include dynamic random access memory (DRAM), which typically constitutes a main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Data stores may be associated with various computing devices and may include a relational database management system (RDBMS). An RDBMS generally employs Structured Query Language (SQL) in addition to a language for creating, storing, editing, and executing stored procedures, such as the PL/SQL language mentioned above. However, it is to be understood that data stores associated with a computing device may be some other kind of database such as a hierarchical database, a set of files, an application database in a proprietary format, etc. A data store often includes a computing device employing a computer operating system such as one of those mentioned above, and are accessed via a network in any one or more of a variety of manners, as is well known.

FIG. 2 illustrates an exemplary question tree 130, including a plurality of questions 205. The questions 205 are generally related to a form such as the Access Service Request form mentioned above. Arrows connecting respective questions 205 illustrated in FIG. 2 represent possible paths through the question tree 130, i.e., a possible procession from one question 205 to another. Each question 205 may have two or more possible answers. Such answers may be presented for user selection in GUI 110, various examples of questions 205 and possible answers to questions 205 being illustrated in FIGS. 4-11, discussed below. Upon a user selection of an answer to a question 205, a subsequent question 205 is presented in GUI 110 according to the selected answer. Further, user selection of answers to certain questions 205 may result in display of configuration output 135, e.g., as illustrated in FIG. 12.

FIG. 3 illustrates an exemplary process 300 for using a question tree 130 to obtain configuration output 135. Process 300 may be executed according to instructions included in configuration assistance application 125. In general, as noted above, configuration output 135 pertains to a product and/or service desired by a user of client 105. Thus, an object of FIG. 3 is to provide configuration output 135 that informs the user concerning information to be provided on a form for obtaining the desired product and/or service.

Process 300 may begin in a step 305, in which a user may select an answer to a question 205 displayed in GUI 110. As described herein, process 300 may execute step 305 multiple times. The first time step 305 is executed, a predetermined question 205 is initially displayed in GUI 110. Questions 205 displayed in GUI 110 in subsequent executions of step 305 are selected according to answers to prior questions 205.

Next, in step 310, the answer selected in step 305 is evaluated to determine whether another question 205, along with possible answers thereto, should be displayed in GUI 110. If so, process 300 returns to step 305. However, it may be determined upon receipt of an answer to the question presented in step 305 that information required to present configuration output 135 has been obtained, in which case step 315 is executed next.

In step 315, with reference to a form such as the Access Service Request form mentioned above, form fields required to be filled in based on answers to questions 205, e.g., received as described above with respect to step 305, are determined. Further, appropriate values for such form fields are determined.

Next, in step 320, with reference to a form such as the Access Service Request form mentioned above, fields required to be omitted are determined based on answers to questions 205, e.g. received as described above with respect to step 305.

Next, in step 325, configuration output 135 is provided. An example of configuration output 135 is provided in FIG. 12. In general, configuration output 135 lists fields in a form such as the Access Service Request form mentioned above that should be populated to request a desired product and/or service, along with values for populating the fields. Further, configuration output 135 generally lists fields in the form that should not be populated.

Next, in step 330, it is determined whether user input has been received to edit answers to any of the information displayed in configuration output 135. If such user input has been received, process 300 returns to step 305 to obtain the user's answer to the question 205 related to the information indicated by user input received in this step 330. Process 300 then proceeds from step 305 as described above. However, if no such input is received, or if an “exit” button or the like within configuration output 135 is selected, process 300 and following step 330. Of course, a user can generally edit prior questions when proceeding through steps 305 and 310 by selecting a back button or otherwise navigating back to the prior question.

FIGS. 4-12 provide exemplary illustrations of GUI 110 as it may be provided by configuration assistant application 125 as a user of client 105 navigates through a question tree 130. The exemplary implementation of configuration assistant application 125 illustrated in FIGS. 4-12 is designed to provide configuration output 135 indicating to a user of client 105 fields to be completed in an Access Service Request form, along with values for such fields. The exemplary configuration output 135 is also designed to indicate to the user of client 105 fields in the Access Service Request form that are not to be completed.

FIG. 4 illustrates GUI 110 as it may be provided by configuration assistant application 125 when initially accessed by a user of client 105. Generally, configuration assistant application 125 should seek information from a user of client 105 concerning desired service. Often, a first question to be asked concerning desired service relates to a geographic area in which the desired service is to be provided. Accordingly, in the example of FIG. 4, a drop-down input box is provided for a user to indicate a state in which service is to be provided. Of course, providing services according to geographic areas other than or in addition to states is possible. For example, in one implementation a user may provide an indication of a state for desired service, whereupon application 125 may assign the user to a geographic region to which the selected state has been assigned, e.g., North, South, West, East, etc.

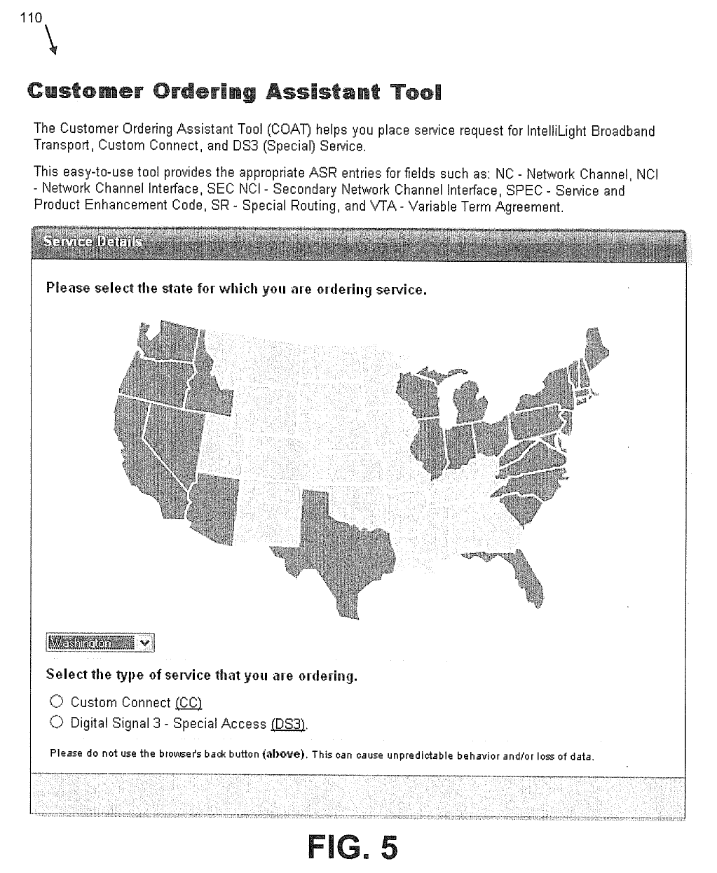

FIG. 5 illustrates GUI 110 as it may be provided by configuration assistant application 125 after a state for service has been selected as described above with reference to FIG. 4. For example, FIG. 5 shows the state of Washington having been selected. Based on this election, as shown in FIG. 5, a user is prompted to select a type of service being ordered. In the example of FIG. 5, a user is prompted to select between “Custom Connect” and Digital Signal 3—Special Access” services. Of course, different services could be associated with the state of Washington, or with different states, had a user selected a different state. Further, for certain states or geographic regions, additional questions concerning a type of service, a location for service, etc. may be necessary or desirable.

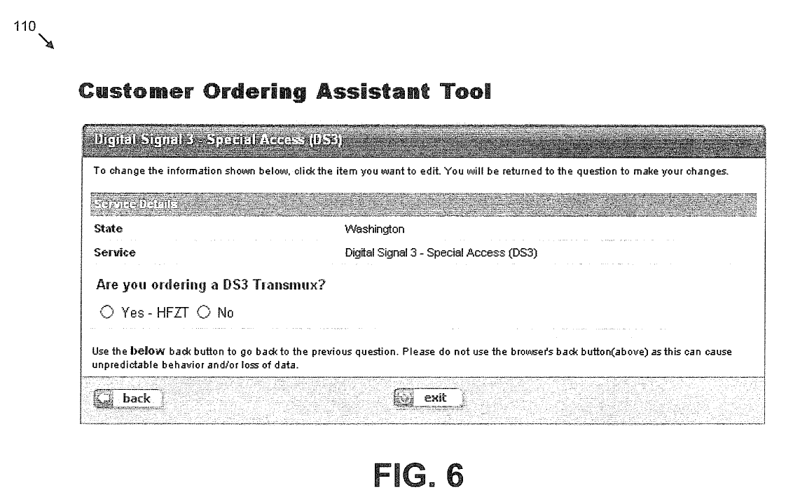

FIG. 6 illustrates GUI 110 after “Digital Signal 3—Special Access” is selected as a service in the GUI 110 of FIG. 5. FIG. 6 illustrates asking the question “Are you ordering a DS3 Transmux?” A Transmux, or Transmultiplexer, is a device capable of converting a plurality of analog transmissions to a single digital bitstream. An answer to this or a similar question allows application 125 to determine a network channel (NC) for the services being ordered. This and other information provided through GUI 110 allows application 125 to determine fields to be populated and fields not to be populated in the Access Service Request form.

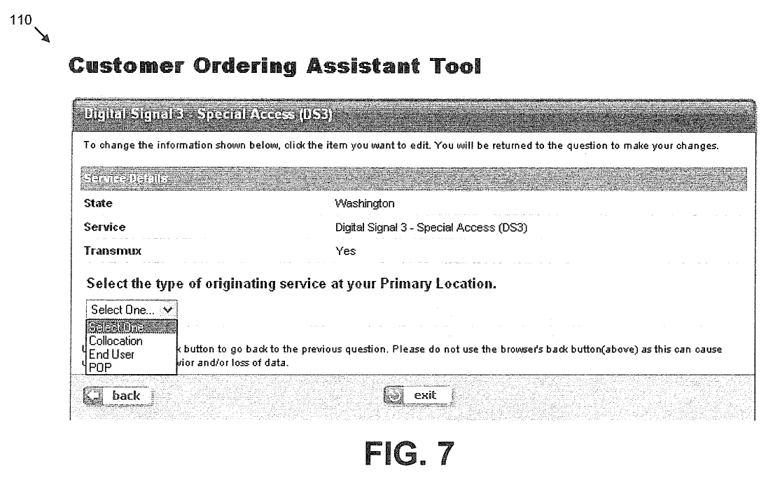

FIG. 7 illustrates GUI 110 after a user has answered “yes” to the question described above with respect to FIG. 6. FIG. 7 illustrates asking the user to “Select the type of originating service at your Primary Location.”

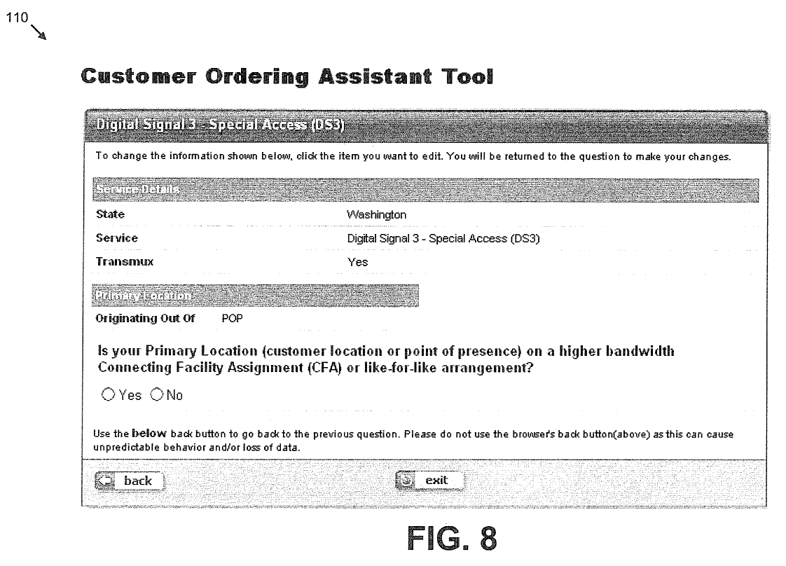

FIG. 8 illustrates GUI 110 after a user has selected point of presence (“POP”) as the type of originating service at the user's Primary Location in response to the question of FIG. 7. FIG. 8 illustrates asking the user “Is your Primary Location (customer location or point of presence) on a higher bandwidth Connecting Facility Assignment (CFA) or like-for-like arrangement?”

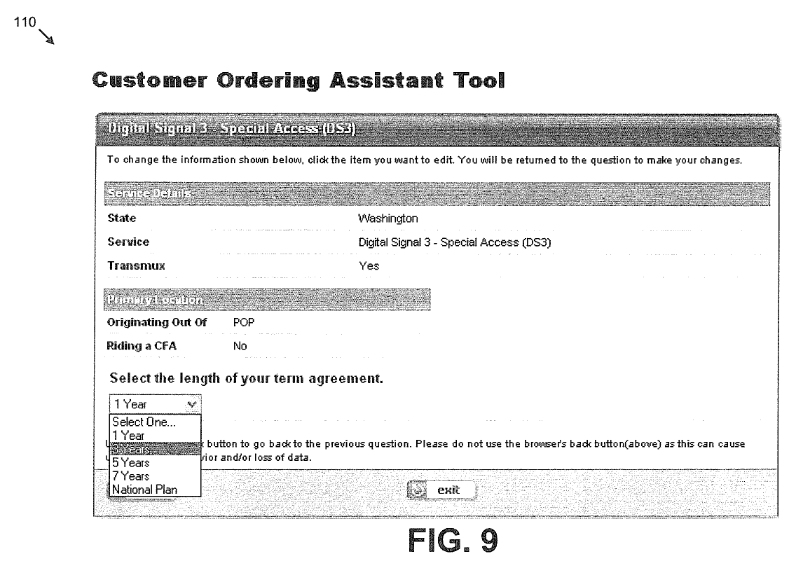

FIG. 9 illustrates GUI 110 after a user has answered “no” to the question illustrated in FIG. 8. FIG. 9 illustrates asking the user to “Select the length of your term agreement.”

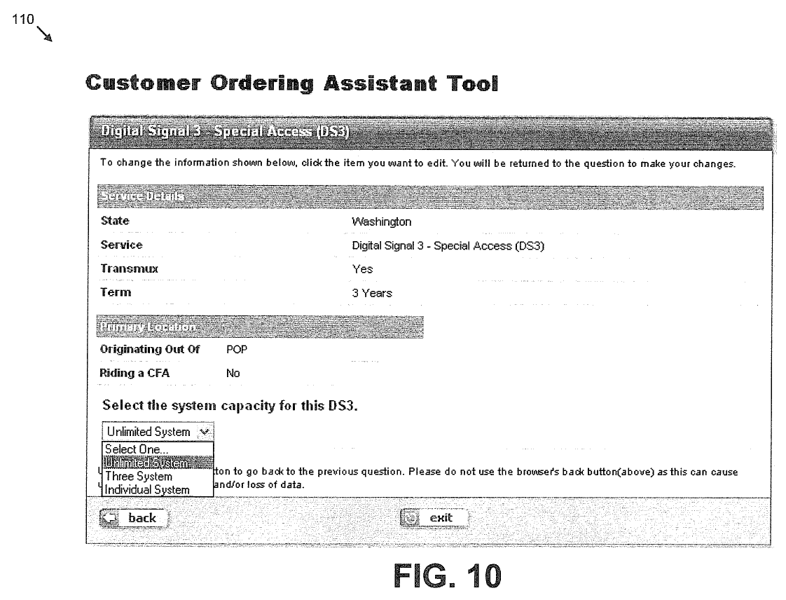

FIG. 10 illustrates GUI 110 after a user has answered “3 Years” in response to the question illustrated in FIG. 9. FIG. 10 illustrates asking the user to “Select the system capacity for this DS3.”

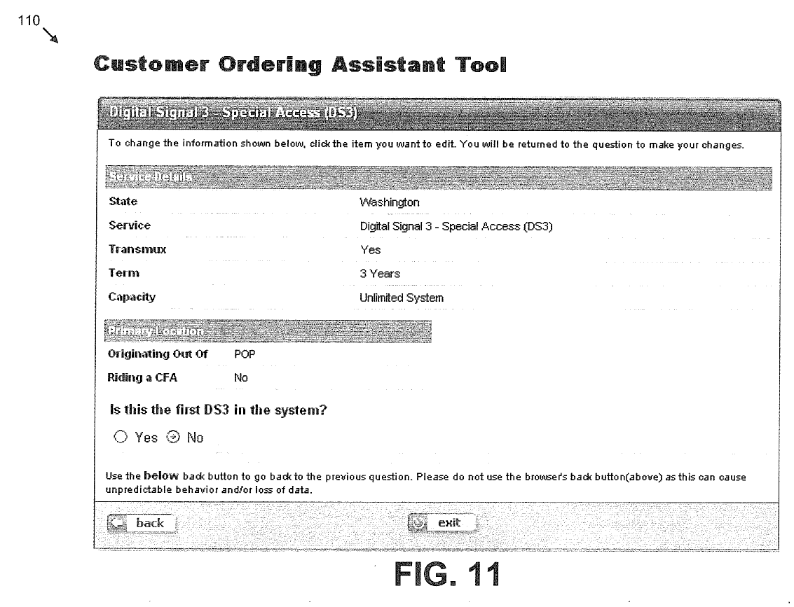

FIG. 11 illustrates GUI 110 after a user has selected “Unlimited System” capacity in response to the question illustrated in FIG. 10. FIG. 11 illustrates asking the user “Is this the first DS3 in the system?”

FIG. 12 illustrates a display of configuration output 135. As can be seen in FIG. 12, configuration output 135 provides information concerning fields to be populated in and Access Service Request form, along with values for those fields. Further, configuration output 135 identifies fields in Access Service Request form that cannot be populated in order to obtain the desired service. Configuration output 135 further provides details concerning service and a primary location for service. Service details include information such as a geographic location for the service, a term for the service, information concerning whether certain hardware components are present, e.g., a transmux, the capacity of the system being ordered, etc. Information relating to a Primary Location relates to where a service originates with respect to a service provider, e.g., a point of presence, a collocation, etc.

Configuration output 135 also provides a mechanism whereby a user may select an item relating to service details or location for editing. A user may thus easily and in a conveniently usable format obtain information needed to populate an Access Service Request form. Further, it is possible for configuration assistant application 125 to generate an electronic version of an Access Service Request form that is properly populated based on information included in configuration output 135. Such a version of an Access Service Request form may be printed or electronically transmitted to a provider.

### Conclusion

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain systems, and should in no way be construed so as to limit the claimed invention.

Accordingly, it is to be understood that the above description is intended to be illustrative and not restrictive. Many systems and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future systems. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites explicitly to the contrary.

What is claimed is:

1. A method, comprising:
receiving a request to configure an order for services;
accessing a question tree, the question tree being related to a form that may be used to place the order;
receiving user responses to two or more questions included in the question tree; and
providing a configuration output that identifies fields in the form to be populated and values for the fields in the form that are to be populated.

2. The method of claim 1, further comprising including in the configuration output an identification of fields in the form that cannot be populated to place the order.

3. The method of claim 1, further comprising including service details in the configuration output.

4. The method of claim 2, further comprising receiving input to edit at least one of the service details.

5. The method of claim 1, further comprising:
receiving a first user response to a first question in the question tree; and
accessing a second user question in the question tree based on the first user response.

6. The method of claim 1, wherein the request is received via a network.

7. The method of claim 1, wherein the form is an Access Service Request form for telecommunications services.

8. A computer readable medium tangibly embodying computer-executable instructions, the instructions including instructions for:
receiving a request to configure an order for services;
accessing a question tree, the question tree being related to a form that may be used to place the order;
receiving user responses to two or more questions included in the question tree; and
providing a configuration output that identifies fields in the form to be populated and values for the fields in the form that are to be populated.

9. A system, comprising:
a first computer-readable medium that includes a question tree;
a second computer-readable medium that includes a configuration assistant application that is configured to:
receive a request to configure an order for services;
access a question tree, the question tree being related to a form that may be used to place the order;
receive user responses to two or more questions included in the question tree; and
provide a configuration output that identifies fields in the form to be populated and values for the fields in the form that are to be populated.

10. The system of claim 9, wherein the first computer-readable medium and the second computer-readable medium are portions of one computer-readable medium.

11. The system of claim 9, the configuration assistant being further configured to include in the configuration output an identification of fields in the form that cannot be populated to place the order.

12. The system of claim 9, the configuration assistant being further configured to include service details in the configuration output.

13. The system of claim 12, the configuration assistant being further configured to receive input to edit at least one of the service details.

14. The system of claim 9, the configuration assistant being further configured to:
receive a first user response to a first question in the question tree; and
access a second user question in the question tree based on the first user response.

15. The system of claim 9, wherein the request is received via a network.

16. The system of claim 9, wherein the form is an Access Service Request form for telecommunications services.

17. A system, comprising:
a server that is configured to access a data store that includes a question tree, the server being further configured to:
receive a request to configure an order for services;
access a question tree, the question tree being related to a form that may be used to place the order;
receive user responses to two or more questions included in the question tree; and
provide a configuration output that identifies fields in the form to be populated and values for the fields in the form that are to be populated.

18. The system of claim 17, the server being further configured to include in the configuration output an identification of fields in the form that cannot be populated to place the order.

19. The system of claim 17, the server being further configured to:
receive a first user response to a first question in the question tree; and
access a second user question in the question tree based on the first user response.
